(19) United States
(12) Patent Application Publication
(10) Pub. No.: US 2007/0110846 A1
(43) Pub. Date: May 17, 2007

(54) STANDARD LOAVES, PROCESS AND INSTALLATION FOR OBTAINING THEM

(75) Inventors: Javier Llavina Nadal, Granollers (Barcelona) (ES); Josep Mª. Aguila Plassa, Barcelona (ES)

Correspondence Address: DARBY & DARBY P.C., P. O. BOX 5257, NEW YORK, NY, 10150-5257, US

(73) Assignee: BIMBO, S.A., Barcelona (ES)

(21) Appl. No.: 11/560,655

(22) Filed: Nov. 16, 2006

(30) Foreign Application Priority Data
Nov. 16, 2005 (ES) 200502807

(51) Int. Cl. A21D 8/02

(52) U.S. Cl. 426/19

(57) ABSTRACT

Process for obtaining standard loaves which includes the stages of introducing bread dough into a mould and baking said bread dough in the mould, characterised in that baking comprises a stage of microwave irradiation of the dough, the dough being contained in a mould made of a material suitable for microwaves.

### CROSS-REFERENCE TO RELATED APPLICATIONS

This application claims priority to Spanish patent application Ser. No. 200502807 filed Nov. 16, 2005, the contents of which are hereby incorporated by reference in its entirety.

### DESCRIPTION

The present invention relates to standard loaves having novel characteristics and to a process and installation for obtaining them.

The consumer perceives the crust of standard loaves as a drawback owing to its differing characteristics, compared to the crumb of the bread, these characteristics resulting from the toasting which occurs during the baking process. In particular, the crust of conventional standard loaves has a bitter taste which is rejected by numerous consumers. According to research carried out by the applicant, some 90% of consumers stated that they had sometimes removed the crust from standard loaves, while more than 50% stated that they do so regularly. In recent years, therefore, there has been a proliferation of loaves for sale, from which the crust has previously been cut.

However, removal of the crust by cutting involves the addition of an extra operation and the creation of waste, and this makes the product more expensive.

The applicant has accordingly investigated the method of obtaining loaves which do not have a crust that may be considered to be a drawback by the consumer, with the resultant satisfaction for the consumer and a saving of costs for the consumer and for the manufacturer.

The applicant declares, in accordance with Article 5.2.c) of the Rules for the implementation of the Spanish patent law, that it does not know of any other prior art which is relevant to this application.

In accordance with the investigations carried out by the inventors, the rejection of the crust by consumers is due to its differing characteristics from the remainder of standard loaves. In particular, the crust has a texture, colour, moisture content, elasticity and organoleptic properties which differ on account of the dehydration and toasting of the external layer of the bread dough which is produced during the baking process (usually at a temperature of approximately 215 to 230° C.).

To solve the above-described problems, the present invention discloses a process for obtaining standard loaves which comprises stages of introducing bread dough into a mould and baking said bread dough in the mould, which is characterised in that baking comprises a stage of microwave irradiation of the dough. For this purpose, the mould into which the dough is introduced would have to be of a material suitable for microwaves.

The degree of baking will thus be similar in all points of the loaves and toasting of the surface can be avoided.

According to a preferred embodiment, baking will additionally comprise a subsequent step of baking in a conventional oven, by thermal radiation, such as an infrared oven, or by convection.

Preferably, the amount of energy irradiated during the microwave irradiation stage will be between 0.5 kWh/kg and 0.15 kWh/kg of product, and more preferably will be approximately 0.10 kWh/kg of product.

In another preferred embodiment, the duration of the microwave irradiation stage will be between 4 and 12 minutes, more preferably between 6 and 10 minutes. According to another preferred embodiment, the power of irradiation will be between 0.6 and 1 kW. The subsequent conventional baking stage can be carried out, for example, at a temperature of between 215° C. and 230° C. for a period of between 2 and 5 minutes.

The present invention also relates to loaves which are characterised in that they comprise an external crust of which the colour is substantially the same as that of the interior, the crust having a lower void density than that of the interior of the loaves. The organoleptic properties of the crust of the standard loaves obtained in accordance with the present invention are basically the same as those of the crumb. In addition, the crust is less tough and more masticable than that of conventional standard loaves.

The present invention also comprises an installation for the industrial production of the standard loaves of the invention in which the bread baking zone has a microwave-emitting unit for baking the standard loaf and, preferably, a conventional bread-baking oven located after (or at the exit of) the microwave-emitting unit. Said installation could also comprise stations for weighing ingredients, kneading, dividing the dough, shaping, leavening at controlled temperature and humidity before the heating unit or units for baking the bread dough, as well as slicing, packaging and labelling installations located after the heating unit for baking the bread. The terms “before” and “after” in this context refer to the path travelled by bread dough along the imaginary production line.

A practical non-limiting example of a preferred method of carrying out the invention is given hereinafter.

A mixture of enriched flour for standard loaves, salt, yeast, drinkable water and vegetable oil (olive oil) in typical proportions for standard loaves of a known type was mixed and kneaded.

1000 grams of the mixture were separated and weighed and were introduced into a standard loaf mould made of a material suitable for introduction into a microwave oven. Said mould was left in temperature and humidity conditions controlled so as to allow leavening of the dough, under conditions known for conventional standard loaves.

Subsequently, the mould containing the leavened dough was introduced into a conventional microwave oven and was heated at a power of 0.8 kW for 8 minutes. Subsequently the dough was baked in the conventional manner for 3 minutes to give the product consistency and to facilitate the demoulding thereof.

A standard loaf not having a toasted crust was obtained. In particular, the crust consists of a light layer having the same colour as the interior and differing in that it has a lower void density. The organoleptic properties in both the crumb and the crust were similar.

1. Process for obtaining standard loaves which includes the stages of introducing bread dough into a mold and baking said bread dough in the mold, wherein said baking comprises a stage of microwave irradiation of the dough, the dough being contained in a mold made of a material suitable for microwaves.

2. Process according to claim 1, wherein said baking further comprises a stage of baking in an oven for heating by thermal radiation, subsequent to microwave irradiation of the dough.

3. Process according to claim 1, wherein the baking further comprises a stage of baking in an oven for heating by convection, subsequent to microwave irradiation of the dough.

4. Process according to claim 2, wherein an infrared oven is used in the stage of baking subsequent to microwave irradiation.

5. Process according to claim 1, wherein the amount of energy irradiated in the microwave irradiation stage is between 0.5 kWh/kg and 1.5 kWh/kg of dough.

6. Process according to claim 5, in which the irradiation energy is approximately 1 kWh/kg of dough.

7. Process according to claim 1, wherein the duration of the irradiation stage is between 4 and 12 minutes.

8. Process according to claim 7, wherein the duration of the irradiation stage is between 6 and 8 minutes.

9. Process according to claim 1, wherein the bread dough is irradiated with a power of between 0.6 and 1 kW.

10. Process according to claim 1, wherein the baking stage subsequent to irradiation has a duration of between 3 and 6 minutes.

11. Process according to claim 1, wherein the baking stage subsequent to irradiation is carried out at an oven temperature of between 215° C. and 230° C.

12. Installation for the industrial production of standard loaves by a process according to claim 1, wherein the loaf baking zone has a microwave emitting unit for baking the standard loaves.

13. Installation according to claim 12, further comprising a conventional oven for baking bread after the microwave-emitting unit.

14. Installation according to claim 12, further comprising installations for weighing ingredients, kneading, dividing the dough, shaping, leavening at controlled temperature and humidity before the heating unit for baking the baking the bread dough.

15. Installation according to claim 12, further comprising slicing, packaging and labeling installations located after the heating unit for baking the bread.

16. A standard loaf produced by a process according to claim 1, having a crust substantially of the same color as the crumb.

17. A standard loaf according to claim 16, wherein the crust differs from the crumb in that it has a lower void density.

18. A standard loaf according to claim 16, wherein the crust has substantially the same organoleptic properties as the crumb.
